(19) United States
(12) Patent Application Publication
(10) Pub. No.: US 2026/0203114 A1
(43) Pub. Date: Jul. 16, 2026

(54) DATA PROCESSING SYSTEM

(71) Applicant: Arm Limited, Cambridge (GB)

(72) Inventors: Ozgur TASDIZEN, Cambridge (GB); Daren CROXFORD, Swaffham Prior (GB)

(21) Appl. No.: 19/016,171

(22) Filed: Jan. 10, 2025

(51) Int. Cl. G06F 9/50

(52) U.S. Cl. CPC G06F 9/5027

(57) ABSTRACT

A method of operating a data processing system, a data processing system, and a computer program product. The data processing system includes processors operable to process a job, wherein the job is divided into tasks, and each processor of the plurality of processors is operable to process one or more tasks of the job. The data processing system defines a volume having two or more predetermined dimensions, wherein the volume includes at least part of the job, and divides the volume into regions based on one or more predetermined dimensions of the volume, one or more corresponding dimensions of a task and the number of processors, each region having an initial region size and each region includes spatially proximate tasks. Each of the regions are initially allocated to a processor, and a task within a region is allocated to the processor that is allocated to the region.

### FIELD

The present disclosure relates to data processing systems and, in particular, to data processing systems having a plurality of processors for processing a job that includes a plurality of tasks.

### BACKGROUND

Many data processing systems include a plurality of processing resources (e.g. processing cores) that may each process different processing tasks in parallel to one another. This allows a larger processing job to be split into smaller processing tasks that are submitted to different ones of the processing resources for processing, to thereby complete the processing of the larger processing job.

In data processing systems that comprise a plurality of independent processors, different tasks of a job may be processed in parallel by different processors (cores), thereby potentially reducing the time taken to process the job. To control the processing of different tasks by different processors, the tasks may be allocated to particular respective processors for processing and the processors may successively process the tasks allocated to them until all of the required tasks of the job have been processed. Which tasks of a job are allocated to which processors may be controlled according to the availability of the respective processors and a predetermined allocation order for the tasks of the job.

The Applicants believe that there remains scope for improvements to the operation of data processing systems that comprise a plurality of rendering processors.

### SUMMARY

According to a first aspect of the present disclosure there is provided a method of operating a data processing system that comprises a plurality of processors operable to process a job, wherein the job is divided into a plurality of tasks, and each processor of the plurality of processors is operable to process one or more tasks of the job, the method comprising: defining a volume having two or more predetermined dimensions, wherein the volume includes at least part of the job; dividing the volume into a plurality of regions based on one or more predetermined dimensions of the volume, one or more corresponding dimensions of a task and the number of processors, each region having an initial region size and each region includes spatially proximate tasks; initially allocating each of the plurality of regions to a processor of the plurality processors; and allocating a task within a region to the processor that is allocated to the region.

In some embodiments, the method may further comprise: identifying that the plurality of regions of the initial region size do not align with the number of processors; adjusting the initial region size to an adjusted region size lower than the initial region size; allocating each of the plurality of regions of the adjusted initial region size to a processor of the plurality of processors; determining a shared region corresponding to one or more tasks not included in the allocated regions of the adjusted initial region size; and enabling tasks in the shared region to be allocated to any of the plurality of processors.

In some embodiments, if a processor completes processing tasks in the processors allocated region, the method may further comprise: processing one or more tasks of the shared region; and/or processing one or more tasks of a region allocated to a different processor.

In some embodiments, each region may correspond to: a horizontal region having a height corresponding to the initial region size; a vertical region having a width corresponding to the initial region size; a box region having an area corresponding to the initial region size; or a hypercube region having a volume corresponding to the initial region size.

In some embodiments, the method may further comprise: determining a level of similarity between the current job and a subsequent job; and if the level of similarity is high, allocating the same or similar regions of the subsequent job to each processor that was allocated the regions in the current job.

In some embodiments, determining a level of similarity may comprise: comparing a camera position and/or direction between the subsequent job and the current job is below with a predetermined threshold; and/or comparing motion vectors generated from the current job and the subsequent job to a predetermined threshold; and/or comparing one or more average luminance values of consecutive jobs to a predetermined threshold.

In some embodiments, the method may further comprise: adaptively adjusting the initial region size for a subsequent job to be processed for one or more processors of the plurality of processors based on data relating to the processing of the current job by the one or more processors of the plurality of processors.

In some embodiments, the data may include a number of tasks processed by each processor, the method may further comprise: comparing the number of tasks processed by each processor; increasing the initial region size for the subsequent job for a first processor that processed more tasks than a second processor during the current job; and decreasing the initial region size for the subsequent job for the second processor that processed fewer tasks than the first processor during the current job.

In some embodiments, the adaptive adjustment of the initial region size may be disabled when a determined similarity is low between the subsequent job and the current job.

In some embodiments, determining similarity may comprise: comparing a camera position and/or direction between the subsequent job and the current job with a predetermined threshold; and/or comparing motion vectors generated from the current job and the subsequent job to a predetermined threshold; and/or comparing one or more average luminance values of consecutive jobs to a predetermined threshold.

In some embodiments, each processor of the plurality of processors may be associated with a queue, each queue storing one or more tasks that are being processed by the processor, or waiting to be processed by the processor for the region allocated to the processor, wherein each queue has a queue limit, the method may further comprise: dynamically adjusting the queue limit for one or more queues of the processor based on a determined complexity of the tasks in the region allocated to the processor.

In some embodiments, determining complexity may comprise: measuring a duration of time to process each task for each processor; and/or measuring a number of tasks processed by each processor.

In some embodiments, each processor of the plurality of processors may be associated with a queue, each queue storing one or more tasks that are being processed by the processor, or waiting to be processed by the processor for the region allocated to the processor, wherein each queue has a queue limit, the method may further comprise: dynamically adjusting the queue limit for one or more queues of the processor based on the processor processing tasks from the shared region.

In some embodiments, the method may further comprise: forming one or more groups of processors, wherein each group includes two or more processors of the plurality of processors; and allocating regions that are spatially proximate to the processors of a group of processors.

In some embodiments, the method may further comprise: allocating tasks in a region to the processor allocated to that region based on a processor scan order, wherein the scan order includes one of a horizontal scan order, a vertical scan order, and a Z scan order.

In some embodiments, the data processor may be a graphics processor, the job may be a fragment job, the volume may be a two-dimensional volume, and the plurality of tasks may be tiles.

In some embodiments, the job may be a compute job, the volume may be a three-dimensional volume, and the plurality of tasks may be compute tasks.

In some embodiments, the job may be a neural job, the volume may be a four-dimensional volume, and the plurality of tasks may be neural tasks.

According to a second aspect of the present disclosure there is provided a data processor, comprising: a plurality of processors operable to process a job, wherein the job includes a plurality of tasks, and each processor of the plural processors is operable to process one or more tasks of the job; a region allocator, wherein the region allocator allocates one or more regions to each of the processors of the plurality of processors; and a task allocator, wherein the task allocator allocates tasks to each of the processors of the plurality of processors; wherein the data processor is operable to implement a method of operating a data processing system that comprises a plurality of processors operable to process a job, wherein the job is divided into a plurality of tasks, and each processor of the plurality of processors is operable to process one or more tasks of the job, the method comprising: defining a volume having two or more predetermined dimensions, wherein the volume includes at least part of the job; dividing the volume into a plurality of regions based on one or more predetermined dimensions of the volume, one or more corresponding dimensions of a task and the number of processors, each region having an initial region size and each region includes spatially proximate tasks; initially allocating each of the plurality of regions to a processor of the plurality processors; and allocating a task within a region to the processor that is allocated to the region..

According to a third aspect of the present disclosure there is provided a computer program product comprising computer readable executable code for implementing a method of operating a data processing system that comprises a plurality of processors operable to process a job, wherein the job is divided into a plurality of tasks, and each processor of the plurality of processors is operable to process one or more tasks of the job, the method comprising: defining a volume having two or more predetermined dimensions, wherein the volume includes at least part of the job; dividing the volume into a plurality of regions based on one or more predetermined dimensions of the volume, one or more corresponding dimensions of a task and the number of processors, each region having an initial region size and each region includes spatially proximate tasks; initially allocating each of the plurality of regions to a processor of the plurality processors; and allocating a task within a region to the processor that is allocated to the region.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### DRAWINGS

Embodiments of the present disclosure will be described with reference to the accompanying drawings, in which:

FIG. 1 illustrates schematically a data processing system, according to one or more embodiments of the present disclosure.

FIG. 2 illustrates schematically an allocation of tasks using a conventional technique.

FIG. 3 illustrates schematically a graphics processor, according to one or more embodiments of the present disclosure.

FIG. 4 illustrates schematically horizontal regions, according to one or more embodiments of the present disclosure.

FIG. 5 illustrates schematically horizontal regions, according to one or more embodiments of the present disclosure.

FIG. 6 illustrates schematically vertical regions, according to one or more embodiments of the present disclosure.

FIG. 7 illustrates schematically box regions, according to one or more embodiments of the present disclosure.

FIGS. 8a to 8c illustrates schematically a shared region, according to one or more embodiments of the present disclosure.

FIG. 9 illustrates schematically an adaptive adjustment of horizontal regions, according to one or more embodiments of the present disclosure.

FIG. 10 illustrates schematically an adaptive adjustment of box regions, according to one or more embodiments of the present disclosure.

FIG. 11 illustrates schematically a grouping of processors, according to one or more embodiments of the present disclosure.

### DESCRIPTION

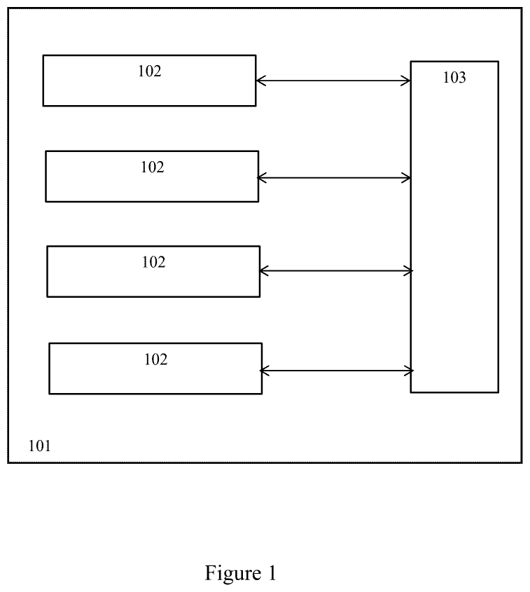

A data processing system may include a plurality of individual (independent) processors, in which different tasks of a job may be processed in parallel by different individual processors (cores), thereby potentially reducing the time taken to process the job. The tasks of a job are typically allocated to individual processors based on availability, e.g. a processor that has completed an, or its, allocated task(s), would simply be allocated the next available task of the job. This is illustrated in FIG. 1 which shows a typical data processing system 101 that includes a plurality of processors 102 and a task allocator 103, which may also be referred to as an iterator. The task allocator 103 divides a job to be processed into a series of tasks which can then be allocated to a particular processor of the plurality of processors 102 depending on the availability of each processor of the plurality of processors 102. However, the Applicants have recognised that this conventional allocation of tasks of a job between the individual processors of the plurality of processors is inefficient and that there remains scope for improvements to the operation of such data processing systems.

For example, in the conventional system each subsequent task that is allocated to an available processor of the plurality of processors may be located anywhere in the job, e.g. spatially separate, meaning that there is no coherency between a task and subsequent tasks that are processed by a processor of the data processing system.

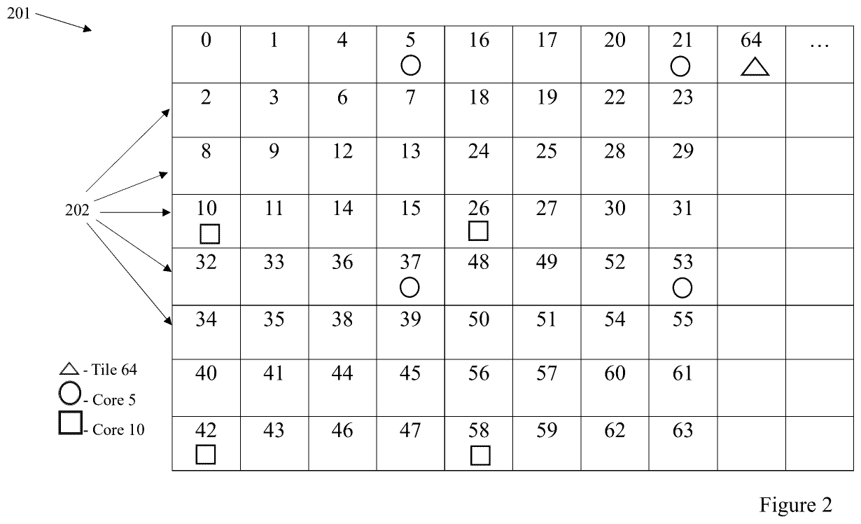

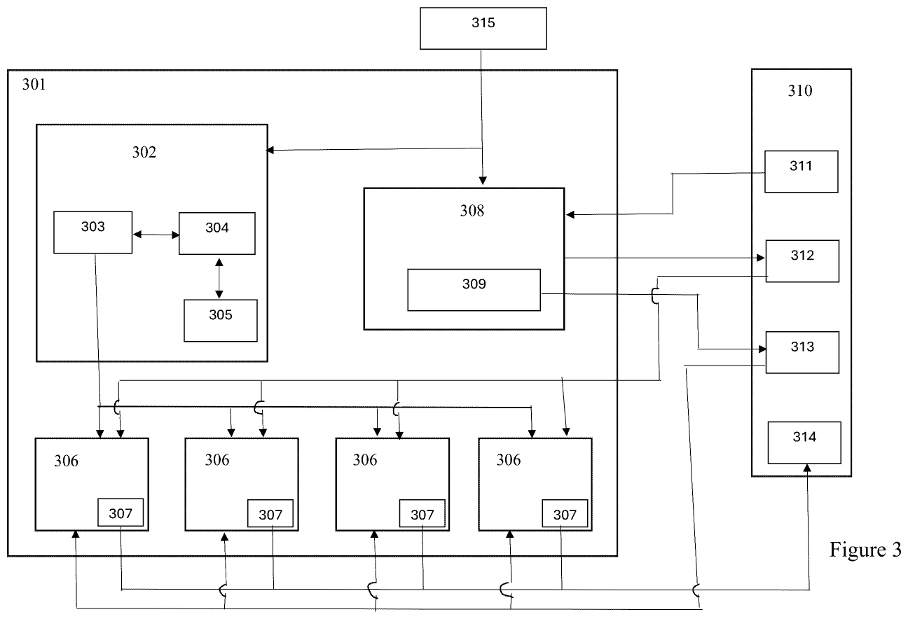

A conventional technique of allocating tasks of a job is shown schematically in FIG. 2. The example of FIG. 2 relates to the data processing system being a graphics processing system comprising a plurality of rendering processors (e.g. shader cores), for rendering a frame (e.g. a job) wherein the frame includes a plurality of tiles (e.g. tasks), to provide a render output. That is, the graphics processing system is operable to perform tile-based graphics processing (e.g. fragment processing) in which tiles that a render output is divided into for rendering purposes can be processed by a rendering processor executing a graphics processing pipeline to process and output a tile separate from the processing or outputting of other tiles. Further explanation of a tile-based graphics processing system is described below in relation to FIG. 3. The example shown in FIG. 2 relates to a frame 201 (e.g. the job) being rendered by a plurality of 16 processors ((shader) cores) to provide a render output to be displayed. The frame 201 includes a plurality of tiles 202 arranged in a two-dimensional array, or matrix. The numbers shown in the tiles 202 represent the allocation order of the tiles to the processors, where in the example of FIG. 2, the tiles are allocated based on round robin scheduling using a local Z scan order (which may also be referred to as a Morton Order) per core. Tiles 0 to 63 have been allocated to various cores and the next tile to be allocated is tile 64 (i.e. the 65^{th} tile), indicated by a triangle in FIG. 2. In the conventional technique, tile 64 will be allocated to the first available core, which can be any of the cores of the graphics processing system. If the next available core happens to be core 5, wherein the tiles that have been processed by core 5 are indicated by a circle in FIG. 2, then there is greater spatial locality as tile 64 is adjacent to tile 21 that has been processed by core 5. However, if the next available core is core 10, wherein the tiles previously processed by core 10 are indicated by a square in FIG. 2, then there is little spatial locality between tile 64 and tiles 10, 26, 42 and 58 that have been processed by core 10.

The Applicants have identified that this poor spatial locality is disadvantageous and inefficient as potentially for each new task allocated to a given processor, data for that task will need to be obtained from a main memory and stored in local cache of the processor. Furthermore, if different processors are allocated tasks that are spatially local to one another then the same, or similar, data will typically have to be obtained from main memory by each of the different processors and stored in each of the different processors local memory, for example, a local cache, a local buffer, and so on, which is highly inefficient. Additionally, poor spatial locality between tasks allocated to a given processor increases the rate of local memory (e.g. local cache) misses for the given processor as the data relevant to the allocated task is likely not previously stored in the local memory, which again is inefficient.

The Applicants have recognised that by controlling the allocation of tasks of a job to the processors for processing based on spatial coherency, or spatial locality, of the tasks then an amount of processing and memory access, e.g. memory bandwidth, expected to be required to be performed to process the tasks of a job can be made more efficient and reduce memory bandwidth. This can allow the processing of a job to be completed by the processors more efficiently, for example, using less bandwidth, lower energy, and higher throughput (as the processor will be stalled waiting for data less), as compared to the conventional techniques.

A job may include a plurality of tasks which need to be processed in order to provide an output for the job. For example, the job may be a be to render an output in a graphics processing system where a task corresponds to, for example, a tile, to perform compute jobs, for example, average a previous set of frames image data where a task corresponds to, for example, a tile, or to perform neural jobs, for example, image denoising, or image upscaling (super resolution. However, as will be appreciated, the graphics processing jobs, compute jobs, and neural jobs, could relate, or be directed to any required jobs to process any type of data, where the jobs include a plurality of tasks.

Each job may be considered to be a 2-dimensional, 3-dimensional, 4-dimensional, and so on up to an N-dimensional, array, or matrix, of tasks that form the job. A volume having the same dimensionality as the job may be defined wherein the volume includes, or encompasses, at least part of the job. The volume may then be divided into a plurality of regions, e.g. two or more regions, based on the dimensions of the volume, the dimensions of the task, and the number of processors in the data processing system. The dimensions may be defined as any suitable dimension for the job that is being processed and the tasks forming the job, for example, in the field of graphics processing the height and width of the volume and the tasks may be defined in pixels, a depth as a number of layers, for example, colour components, e.g. red, green, blue, batch, and so on, depending on the number of dimensions. The number of dimensions will depend upon the type of job being processed by the data processing system and the dimensions of the data being processed.

Each region may have an initial region size, and each region includes spatially proximate tasks. At least one region of the plurality of regions may be allocated to each processor of the plurality of processors, and any tasks that fall within a given region are then subsequently allocated to the respective processor that has been allocated that region, rather than on an ad-hoc basis to any processor that is next available, as in the conventional technique, in, for example, fragment processing in a tile based graphics processing system.

This is advantageous as tasks of a job that are spatially proximate and form part of a defined region can be allocated to the same processor that is processing the defined region. For example, in relation to rendering a frame in graphics processing, as tasks (e.g. tiles to be rendered) within a region that are closely located to one another are typically likely to share at least some rendering state/data (e.g. textures used), thereby increasing the likelihood of being able to exploit this potential spatial coherency by a processor reusing the rendering state/data for successively processed tasks (e.g. tiles) of the defined region, and this can be beneficial to the efficiency of the rendering process. Additionally, by utilising the spatial coherence for each processor in relation to the tasks processed by each processor, a lower power consumption can be achieved, which is highly beneficial for low power devices and further advantageously achieve a higher performance as each processor will spend less time waiting for data. As will be appreciated, the same advantageous effects of the present disclosure, e.g. to improve efficiency by increasing spatial coherency of the tasks forming a job allocated to a processor based on a defined region, equally applies to other graphics processing jobs, compute jobs, neural jobs, and/or any further data processing jobs.

Examples and embodiments of the present disclosure will now be described in relation to the data processing system being a graphics processing system comprising a plurality of rendering processors, for rendering a frame (e.g. a job) wherein the frame includes a plurality of tiles (e.g. tasks), to provide a render output.

In the present examples and embodiments, graphics processing is carried out in a pipelined fashion, with one or more pipeline stages operating on the data to generate the final rendered output, e.g. frame that is displayed.

The present examples and embodiments relate to tile-based graphics processing in which tiles that a render output is divided into for rendering purposes can be processed by a rendering processor executing a graphics processing pipeline to process and output a tile separate from the processing or outputting of other tiles.

FIG. 3 shows schematically the graphics processor 301. The graphics processor 301 is a tile-based graphics processor and includes a geometry processor 308 and plural rendering processors (e.g. renderers/shader cores) 306, all of which can access memory 310. The memory 310 may be local to (e.g. “on chip” with) the geometry processor 308 and rendering processors 306, and/or may be an external memory (e.g. “main” memory) that can be accessed by the geometry processor 308 and the rendering processors 306. Optionally, the graphics processor comprises one unified processor that comprises the geometry processor 308 and the rendering processors 306.

FIG. 3 shows a graphics processor 301 with four rendering processors 306, but other configurations of plural rendering processors can be used if desired, or depending on the configuration of the graphics processing system (e.g. data processing system). For example, the data processing system may include any number of processors (cores).

The memory 310 stores, inter alia, and as shown in FIG. 3, a set of raw geometry data 311 (which may be, for example, provided by a graphics processor driver or an API running on a host system (microprocessor) for the graphics processor 301), a set of transformed geometry data 312 (which is the result of various transformation and processing operations carried out on the raw geometry 311), and a set of binning data structure(s) 313 that allow the primitives required to be processed to process respective tiles of the render output to be determined.

The binning data structure(s) 313 may, for example, comprise primitive lists that each correspond to respective tile(s) that the render output, such as a frame to be displayed, to be generated by the graphics processor 301 is divided into for rendering purposes, and contain data, commands, etc., for the respective primitives that are to be processed for the respective tile(s) that the list corresponds to.

In this case, sets of areas for which primitive lists are prepared are preferably arranged in a hierarchy of sets of areas, wherein each set of areas corresponds to a layer in the hierarchy of sets of areas, and wherein areas for which primitive lists are prepared in progressively higher layers of the hierarchy are progressively larger. Each area for which a primitive list can be prepared in a lowest layer of the hierarchy preferably corresponds to a single tile of the render output. Other configurations for the primitive lists would, however, be possible.

The transformed geometry data 312 comprises, for example, transformed vertices (vertex data), etc.

The geometry processor 308 takes as its input the raw geometry data 311 stored in the memory 310 in response to the graphics processor 301 receiving commands to execute a rendering job 315 from, e.g., a graphics processor driver, and processes that data to provide transformed geometry data 312 (which it then stores in the memory 310) comprising the geometry data in a form that is ready for placement in the render output (e.g. frame to be displayed).

The geometry processor 308 and the processes it carries out can take any suitable form and be any suitable and desired such processes. The geometry processor 308 may, e.g., include a programmable vertex shader that executes vertex shading operations to generate the desired transformed geometry data 312.

As shown in FIG. 3, the geometry processor 308 also includes a tiling unit 309. This tiling unit 309 carries out the process of preparing the binning data structure(s) 313 which is then used to identify the primitives that should be rendered for each tile that is to be rendered to generate the render output (which in this embodiment is a frame to be rendered for display). To do this, the tiling unit 309 takes as its input the transformed and processed vertex data 312 (i.e. the positions of the primitives in the render output), builds binning data structure(s) 313 using that data, and stores those binning data structure(s) as the binning data structure(s) 313 in the memory 310.

To prepare the binning data structure(s) 313, the tiling unit 309 takes each transformed primitive in turn, determines the location for that primitive, and then (if it is determined that the primitive is visible (has not been culled)) includes the primitive in the binning data structure(s) 313 in a manner that allows the area(s) that the primitive in question is determined as potentially falling within (intersecting) to be determined by reading the binning data structure(s). This may be carried out with, for example, a bounding box binning technique, or with an exact binning technique.

In the present embodiment, to process a tile, a rendering processor 306 takes the transformed primitives identified from the binning data structure(s) applying to the tile and rasterises and renders those primitives to, as appropriate, generate rendered graphics data in the form of output fragment (sampling point) data for each respective sampling position within the tile that it is processing. To this end, each rendering processor includes a respective rasterising unit, rendering unit and set of one or more tile buffers 307 that store the rendered data generated by the rendering processor. Once a rendering processor has completed its processing of a given tile, the stored, rendered data for that tile is output from the tile buffer(s) 307 to the output render target, which is a frame buffer 314, which may then be output to, for example, a display, a printer, and so on.

As discussed above, the present embodiments relate to a tile-based graphics processor 301 comprising plural rendering processors 306, in which a job (e.g. frame to be rendered) includes a plurality of tasks (e.g. tiles). The frame may be considered to be a two-dimensional array, or matrix, of tiles, (or even a three-dimensional array or matrix of tiles having a depth of one). A volume is defined in relation to the job, the volume being of the same dimensionality as the job, having one or more predetermined dimensions, and includes, or encompasses, at least part of the job. The volume is then divided into a plurality of regions based on the one or more predetermined dimensions of the volume, one or more corresponding dimensions of a task, and the number of rendering processors. Each region has an initial region size (as in embodiments the region size may be dynamically adjusted as described in more detail below), and each region includes spatially proximate tasks. Each region of the plurality of regions is allocated, or assigned, to a rendering processor such that the rendering processor will process tiles included in the allocated region. The allocation of regions may be performed by a region allocator (region allocation circuit) 303.

In the present embodiment, the region allocator 303 is part of a job controller 302 (which may also be referred to as a Command Stream Frontend (CSF)) of the graphics processor 301. The job controller 302 may further include an allocation buffer 304 that stores a record of the regions allocated to a particular processor, and a task allocator 305 to allocate tasks of a particular region to a respective processor.

Thus, a respective rendering processor can render a region of the render output that it has been allocated by rendering the tile(s) forming part of the allocated region. Accordingly, once a tile of the frame is to be allocated to a processor, the region within which the tile resides indicates which processor the tile is to be allocated to, irrespective of whether that processor is the next available processor, thereby ensuring spatial coherency between tiles (tasks) processed by the processor. Once the rendering processor has processed a tile within its allocated region that it is processing, the rendered data for that tile can be written to the tile buffer 307 from where it can be written out to, for example, the frame buffer 314 (e.g. in the memory 310) for display.

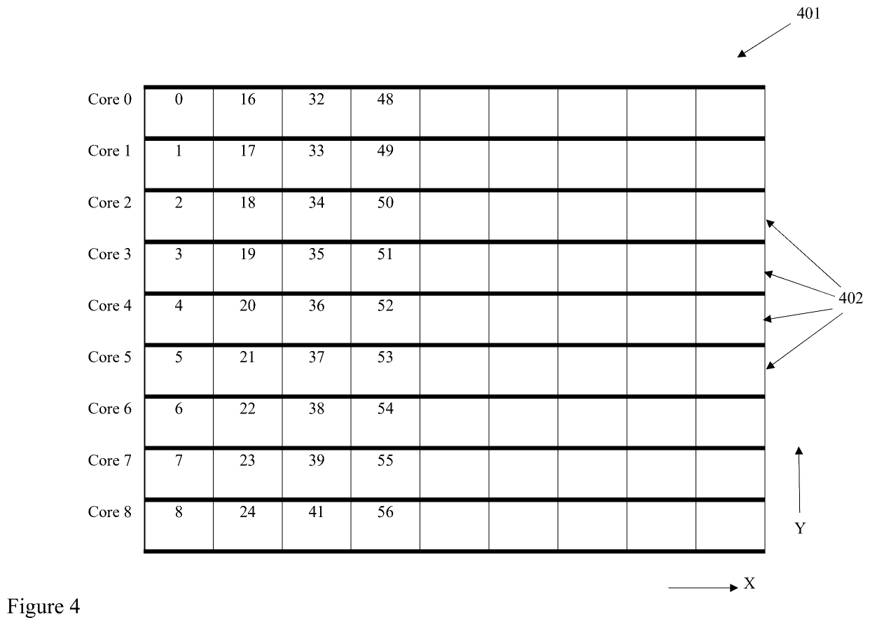

Examples and embodiments of the present technique will now be described in relation to a graphics processing system and with reference to FIGS. 4 to 6.

FIG. 4 shows a graphics processing system (e.g. data processing system) having 16 processors (cores), numbered 0 to 15 where in FIG. 4 only the first 9 cores are shown. A frame (e.g. job) 401 includes a plurality of tiles (e.g. tasks) 402, each tile 402 located at an X and Y coordinate of the frame, for example, from 0,0 through to X, Y. The example of FIG. 4 is based on round robin scheduling using horizontal regions for the 16 cores, with a tile queue depth for each core set at 4, and an initial condition that each core is free of any tiles in the respective queue at the start of the job.

A volume is defined that, in this example, includes, or encompasses, the entire frame and therefore all of the tiles within the frame. The frame height in this example is 1024 pixels (and therefore the volume height) and the height of each tile is 64 sample points, which in this example a sample point is a pixel. As there are 16 cores, the initial region size of each region includes a height of one tile, based on ((volume height/tile height)/number of processors) and a width that extends along the frame in the X dimension (e.g. along the X axis), as this example is utilising a horizontal regions. Thus, the initial region size may be considered to be X×1. In other words, each region corresponds to a row of the frame in this horizontal region example. Each of the 16 regions are allocated to a different core, as shown in FIG. 4.

In FIG. 4, the numbers shown in the tiles indicate the allocation order of that tile. Thus, the tile at frame coordinate 0,0 is the first tile allocated which is in the region allocated to core 0, the tile at frame coordinate 0,1 is the second tile allocated which is in the region allocated to core 1, and so on. In the example, of FIG. 4, it is assumed that each core has a queue limit of 4, i.e. 4 tiles can be queued for each core and that initially the queue of each core was empty when starting the processing of the frame. Thus, tiles 0 to 63 (i.e. the initial 64 tiles to fill the tile queue for each core) can be allocated in order to the respective core that is processing the region the tile is located within in order to fill the task queues of each core. However, the 65^{th} tile to be allocated may be any tile in the next (e.g. 5^{th}) column shown in FIG. 4. For example, if core 3 completed the processing of a tile in its queue first, then the 65^{th} tile to be allocated will be at the coordinates 3, 4, i.e. the next tile in the region allocated to core 3. Similarly, if core 8 completed the processing of a tile in its queue first, then the 65th tile to be allocated will be at the coordinates 8, 4, i.e. the next tile in the region allocated to core 8, and so on.

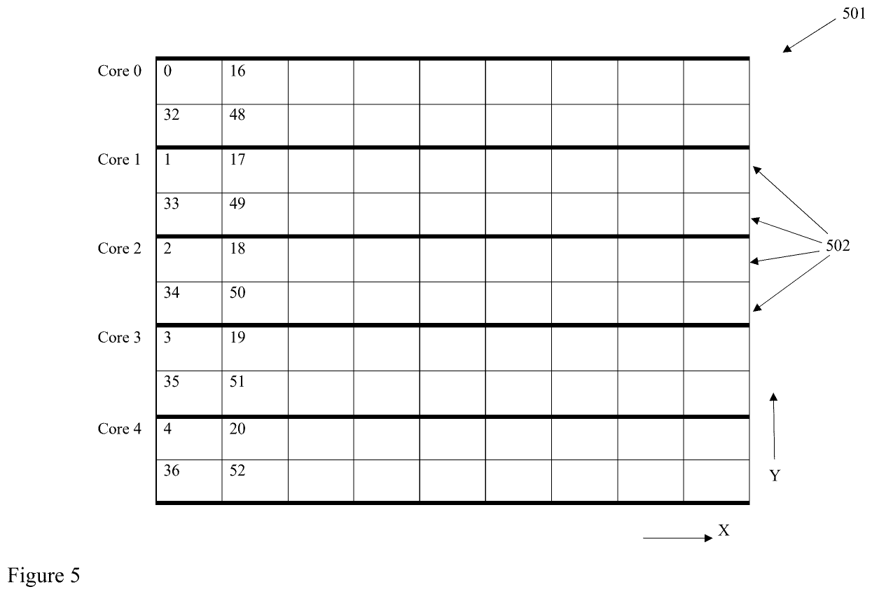

FIG. 5 shows a graphics processing system (e.g. data processing system) having 16 processors (cores), numbered from 0 to 15 where in FIG. 5 only the first 5 cores are shown. A frame (e.g. job) 501 includes a plurality of tiles (e.g. tasks) 502, each tile 502 located at an X and Y coordinate of the frame, for example, from 0,0 through to X, Y. The example of FIG. 5 is based on round robin scheduling using horizontal regions for the 16 cores, with the same initial conditions that each core has a tile queue depth limit of 4 and each core is free of any tiles in the respective queue at the start of the job, as used in FIG. 4 described above.

A volume is defined that, in this example, includes, or encompasses, the entire frame and therefore all of the tiles within the frame. The frame height in this example is 2048 pixels (and therefore the volume height) and the height of each tile is 64 sample points (e.g. pixels), and therefore, as there are 16 cores, the initial region size of each region includes a height of two tiles, based on ((volume height/tile height)/number of processors) and a width that extends along the frame in the X dimension (e.g. along the X axis), as this example is utilising horizontal regions. Thus, the initial region size may be considered to be X×2. In other words, each region corresponds to two consecutive rows of the frame in this horizontal region example. Each of the 16 regions are allocated to a different core, as shown in FIG. 5.

In FIG. 5, the numbers shown in the tiles indicate the allocation order of that tile. In the example of FIG. 5 a local Z scan order is utilised by each of the cores within the allocated region. Thus, the tile at frame coordinate 0,0 is the first tile allocated which is in the region allocated to core 0, the tile at frame coordinate 0,2 is the second tile allocated which is in the region allocated to core 1, and so on, following the Z scan order in each region for each core. In the example, of FIG. 5, it is assumed that each core has a queue limit of 4, i.e. 4 tiles can be queued for each core, and that initially the queue of each core was empty when starting the processing of the frame. Thus, tiles 0 to 63 (i.e. the initial 64 tiles to fill the tile queue for each core) can be allocated in order to the respective core that is processing the region the tile is located within in order to fill the task queues of each core. However, the 65th tile (i.e. tile 64) to be allocated may be any tile in the next (e.g. 3^{rd}) column shown in FIG. 5. For example, if core 1 completed the processing of a tile in its queue first, then the 65th tile to be allocated will be at the coordinates 2, 2, i.e. the next tile in the region allocated to core 1. Similarly, if core 3 completed the processing of a tile in its queue first, then the 65^{th} tile to be allocated will be at the coordinates 2, 6, i.e. the next tile in the region allocated to core 3, and so on.

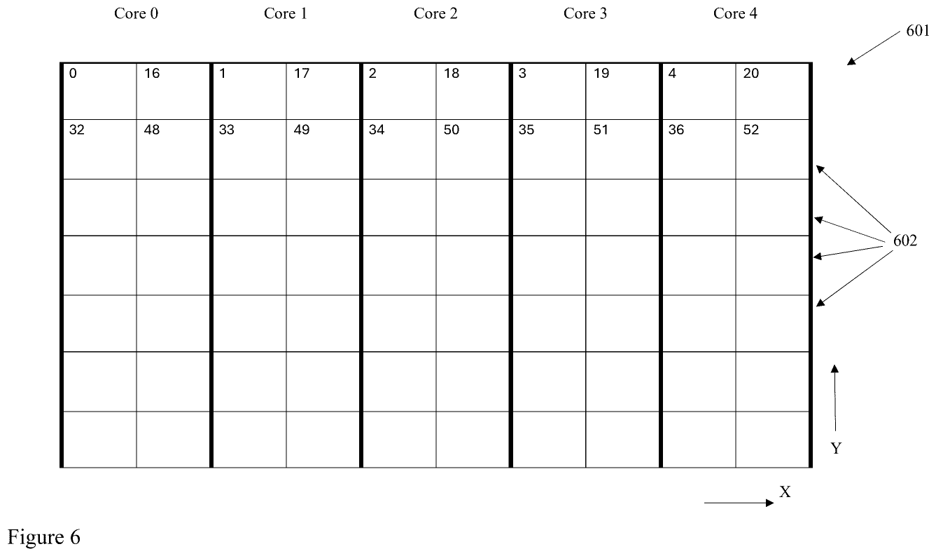

FIGS. 4 and 5 showed examples of round robin scheduling using horizontal regions for 16 cores. However, other regions may equally be utilised, such as vertical regions or box regions. FIG. 6 is an example of round robin scheduling using vertical regions for 16 cores, assuming the same initial conditions that a tile queue depth for each core is set at 4, and an initial condition that each core is free of any tiles in the respective queue at the start of the job. Thus, in FIG. 6, the volume is divided into a plurality of vertical regions (columns), rather than the horizontal regions (rows) as shown in FIGS. 4 and 5.

FIG. 6 shows a graphics processing system (e.g. data processing system) having 16 processors (cores), numbered from 0 to 15 where in FIG. 6 only the first 5 cores are shown. A frame (e.g. job) 601 includes a plurality of tiles (e.g. tasks) 602, each tile 602 located at an X and Y coordinate of the frame, for example, from 0,0 through to X, Y.

A volume is defined that, in this example, includes, or encompasses, the entire frame and therefore all of the tiles within the frame. The frame width in this example is 2048 pixels and the width of each tile is 64 sample points (e.g. pixels), and therefore, as there are 16 cores, the initial region size of each region includes a width of two tiles, based on ((volume width/tile width)/number of processors) and a height that extends along the frame in the Y dimension (e.g. along the Y axis), as this example is utilising vertical regions. Thus, the initial region size may be considered to be 2×Y. In other words, each region corresponds to two consecutive columns of the frame in this vertical region example. Each of the 16 regions are allocated to a different core, as shown in FIG. 6.

In FIG. 6, the numbers shown in the tiles indicate the allocation order of that tile. In the example of FIG. 6 a local Z scan order is utilised by each of the cores within the allocated region. Thus, the tile at frame coordinate 0,0 is the first tile allocated which is in the region allocated to core 0, the tile at frame coordinate 2,0 is the second tile allocated which is in the region allocated to core 1, and so on, following the Z scan order in each region for each core. In the example, of FIG. 6, it is assumed that each core has a queue limit of 4, i.e. 4 tiles can be queued for each core, and that initially the queue of each core was empty when starting the processing of the frame. Thus, tiles 0 to 63 (i.e. the initial 64 tiles to fill the tile queue for each core) can be allocated in order to the respective core that is processing the region the tile is located within in order to fill the task queues of each core. However, the 65th tile (i.e. tile 64) to be allocated may be any tile in the next (e.g. 3rd) row shown in FIG. 6. For example, if core 1 completed the processing of a tile in its queue first, then the 65^{th} tile to be allocated will be at the coordinates 2, 2, i.e. the next tile in the region allocated to core 1. Similarly, if core 3 completed the processing of a tile in its queue first, then the 65^{th} tile to be allocated will be at the coordinates 6, 2, i.e. the next tile in the region allocated to core 3, and so on.

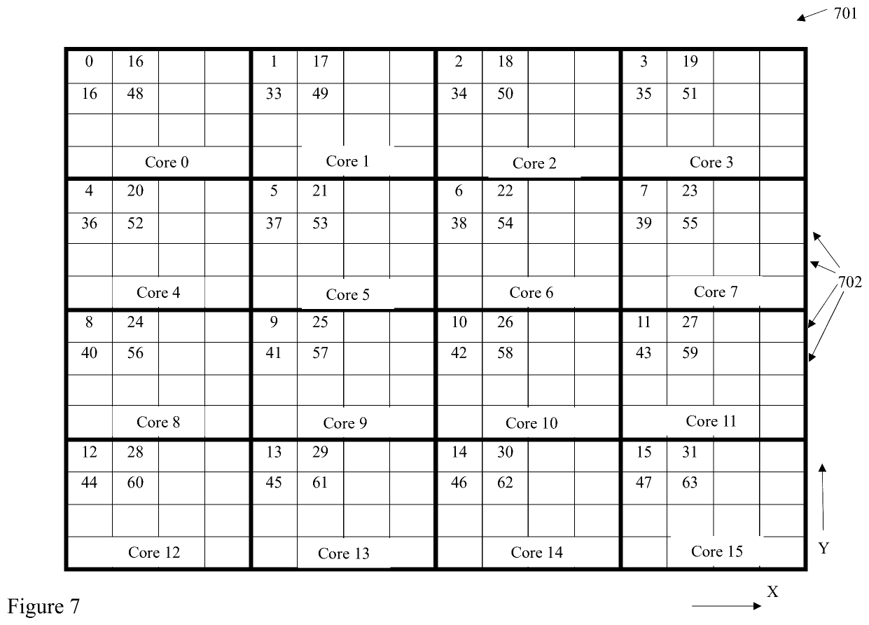

FIGS. 4 to 6 showed examples of horizontal regions and vertical regions. However, other arrangements are possible, for example, box regions where the initial region size corresponds to an area of each region of a plurality of regions that are each to be allocated to a processor of the plurality of processors. With reference to FIG. 7, this figure shows a graphics processing system (e.g. data processing system) having 16 processors (cores), numbered from 0 to 15. A frame (e.g. job) 701 includes a plurality of tiles (e.g. tasks) 702, each tile 702 located at an X and Y coordinate of the frame, for example, from 0,0 through to X, Y.

A volume is defined that, in this example, includes, or encompasses, the entire frame and therefore all of the tiles within the frame. The volume width in this example is 1024 pixels and the volume height is 1024 pixels. The width and height of each tile is 64 sample points (e.g. pixels), and therefore, as there are 16 cores, the initial region size of each region includes an area of 16, based on the volume height and width, the tile height and width, and the number of processors. Thus, each region includes 16 tiles which in the example of FIG. 7 is arranged as 4×4 tiles for each of cores 0 to 15, with the cores forming a 4×4 arrangement, however, other arrangements are possible, for example, in this scenario the cores could be arranged to be 8 high and 2 wide across the volume giving a region for each core of 2×8 tiles (therefore with an area of 16 tiles). Thus, the determination of the regions may further be based on a “logical” arrangement of the cores in relation to the volume where the number of cores in the Y direction are used to determine the initial region size in the Y direction, and the number of cores in the X direction are used to determine the initial region size in the X direction.

In FIG. 7, the numbers shown in the tiles indicate the allocation order of that tile. In the example of FIG. 7 a local Z scan order is utilised by each of the cores within the allocated region. Thus, the tile at frame coordinate 0,0 is the first tile allocated which is in the region allocated to core 0, the tile at frame coordinate 5,0 is the second tile allocated which is in the region allocated to core 1, and so on, following the Z scan order in each region for each core. In the example, of FIG. 7, it is assumed that each core has a queue limit of 4, i.e. 4 tiles can be queued for each core, and that initially the queue of each core was empty when starting the processing of the frame. Thus, tiles 0 to 63 (i.e. the initial 64 tiles to fill the tile queue for each core) can be allocated in order to the respective core that is processing the region the tile is located within in order to fill the task queues of each core. However, the 65th tile (i.e. tile 64) to be allocated may be any tile at the top of the next (e.g. 3^{rd}) column of each core. For example, if core 1 completed the processing of a tile in its queue first, then the 65th tile to be allocated will be at the coordinates 7, 0, i.e. the next tile in the region allocated to core 1. Similarly, if core 3 completed the processing of a tile in its queue first, then the 65th tile to be allocated will be at the coordinates 15, 0, i.e. the next tile in the region allocated to core 3, and so on.

In the above examples shown in FIGS. 4 to 7, the defined volume aligned with the frame (job) such that the tiles (tasks) in at least one dimension are evenly divided between the cores (processors). However, this may not always be the case.

Therefore, in embodiments, it may be identified that the volume is not aligned with the frame such that the initial region size may not an integer value, e.g. each region includes a part of a tile, or several tiles may not be aligned with the determined regions. In other words, the plurality of regions of the initial region size do not align with the number of processors. In this case, the initial region size for each of the processors may then be adjusted to an adjusted initial region size lower than the initial region size, For example, by reducing the initial region size such that each adjusted region size includes a number of tasks that can be divided between the regions and allocated to each core, wherein the remaining tasks not included within any of the regions of the adjusted region size, form a shared region. For example, the shared region may be considered as additional core(s) when determining the regions for allocation to the cores. Thus, the shared region may include any number of tasks that did not evenly distribute to the regions assigned to each processor of the plurality of processors based on the volume. Tasks included in the shared region may subsequently be enabled to be allocated to any available processor and as such the shared region is shared between the processors rather than being allocated to any particular processor.

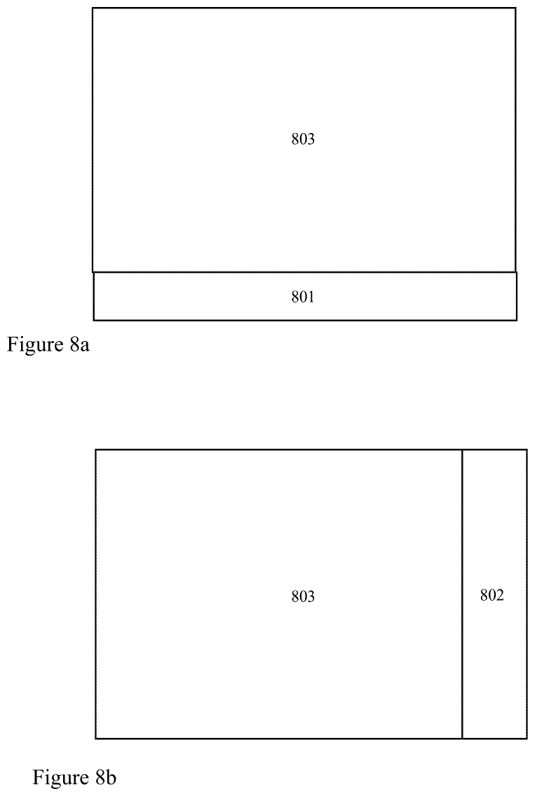

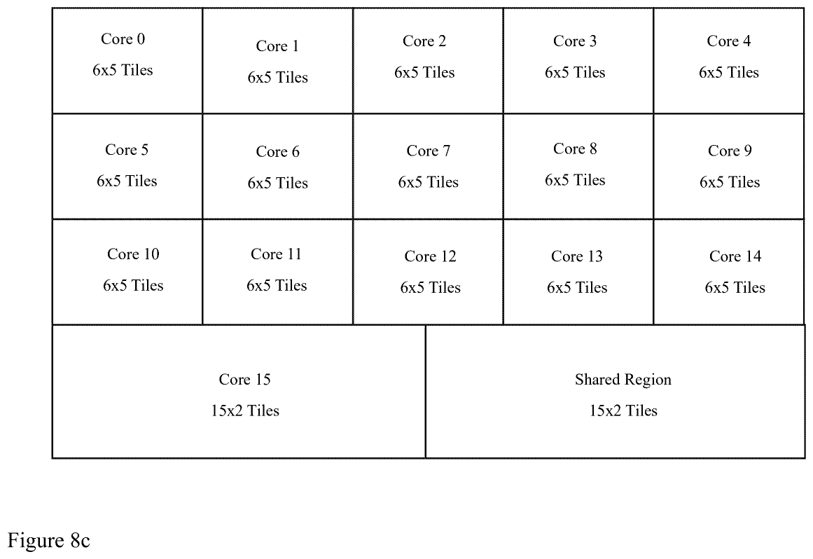

In embodiments, once a processor has completed all of the tasks within the region allocated to that processor and is available, then task(s) of the shared region are enabled to be allocated to the processor. This is shown in FIGS. 8a to 8c. In FIGS. 8a and 8b, a shared region 801 is shown for the horizontal regions where the height of the volume (e.g. frame) is 1080 pixels, and a shared region 802 is provided for the vertical regions where the width of the volume (e.g. frame) is 1080 pixels, respectively. Region 803 shown in FIGS. 8a and 8b relate to the plurality of regions that have been allocated to a particular processor, for example, as described in relation to FIGS. 4 and 5.

In FIG. 8c, the volume encompasses the frame (job) with a width of 1920 pixels and a height of 1080 pixels, the tile are of a height and width of 64 pixels. Thus, the volume does not align to provide an even distribution of tiles to each of the 16 cores as the volume tile grid size is 30×17 tiles. The initial region size (area) is 30 tiles and as such cores 0 to 14 are allocated a region of 6×5 tiles and core 15 is allocated a region of 15×2 tiles and a shared region is 15×2 tiles.

In the above description of the shared region, the shared region is optional, in that the size of one or more of the regions may be increased and assigned to one or more of the cores. For example, in FIG. 8a, the 15^{th} core may be allocated a region that is increased in size to include one or more additional horizontal rows that may have been allocated as a shared region, in FIG. 8b, the 15^{th} core may be allocated a region that is increased in size to include the one or more additional columns that may have been allocated as a shared region, and in FIG. 8c, the 15^{th} core may be allocated a region that is increased in size to include the shared region, that is a 30×2 region. Other arrangements are possible, for example, after the first frame (e.g. job) has been processed it may be determined that one or more cores processed the tiles (e.g. tasks) of its allocated region and several, or all, of the tasks of the shared region such that the core may be allocated a larger region for the subsequent frame (e.g. job) thereby removing the need for a shared region in the subsequent frame, especially if the subsequent frame has a high level of similarity to the current frame.

In embodiments, if a processor has completed all of the tasks within the region allocated to that processor and tasks associated with any shared region have been completed (if such a shared region exists), then the available processor may be allocated tasks of a region allocated to a different processor, where those tasks have not yet been allocated.

A sequence of jobs may be processed by the data processing system in which there is no, or a minor, change between the next job and the previous job that has completed such that the current job and the previous job have a high similarity. For example, in graphics processing there may be little or no change between subsequent frames for rendering a scene. Thus, if the current job is of high similarity to the previous job, for example, is above a similarity threshold, then data relating to the processing of the previous job may be used to adaptively adjust the region size for one or more processors when processing the current (e.g. next) job. For example, similarity may be determined based on whether the camera position and direction has changed between frames, with little or low change (defined by a predetermined threshold) meaning that the frames are likely to have a high similarity. Alternatively, or additionally, similarity may be determined using (per pixel) motion vectors generated from one frame to the next frame, wherein if the motion vectors are below a given threshold then the frames may be considered to be similar and, conversely, if the motion vectors are over a given threshold the frames may be considered not to be similar. Alternatively, or additionally, similarity may be determined by comparing one or more average luminance values of consecutive frames (e.g. two or more of the previous frame(s), current frame and subsequent frame(s)), wherein if the difference between the average luminance values is below a given (e.g. predetermined) threshold, then the frames may be considered to be similar and, conversely, if the difference between the average luminance value is over a given threshold the frames may be considered not to be similar.

Various data may be utilised for adaptively adjusting the region size of one or more processors, for example, a number of tasks processed, or completed, by each processor of the plurality of processors may be compared to determine which processors completed a greater number of tasks than another processor, or to capture the amount of time each tile (e.g. task) took to process (in the previous frame (i.e. job)), and/or if the camera location/direction of the next frame is similar to the current frame then it can be assumed that the tile (e.g. task) complexity would be similar for the next frame. The region size for the processors can be adaptively adjusted to increase or decrease in size. For example, the region size for processors that completed a greater number of tasks may be increased whilst the region size for processors that completed fewer tasks may be decreased. In the example of a graphics processor rendering a frame, the frame may include an area that relates to less complex open sky and an area that relates to more complex buildings. Thus, the region that include the open sky may be completed by the allocated processor prior to the region that includes the more complex buildings such that the processor allocated to the region of open sky may then be allocated tasks of the region that includes the more complex buildings to maintain utilisation of all of the processors and to complete the job with higher efficiency. Thus, the processor originally allocated the region that includes open sky will process and complete more tasks than the processor allocated the region that includes the more complex buildings, meaning that on the next frame the region size of the processor allocated the open sky may be increased and the region size of the processor allocated the more complex building region may be decreased. Additionally, or alternatively, the initial region size of one or more processors may be adaptively adjusted to remove a shared region. For example, a processor that completes its allocated region and was subsequently allocated tasks from the shared region may, for a subsequent frame, have the region size increased to include, at least partially, the shared region. Thus, by adaptively adjusting the region size allocated to two or more processors, the present disclosure advantageously enables all of the processors to complete their allocated task effectively simultaneously, or substantially simultaneously, thereby minimising latency and improving efficiency of the data processing system.

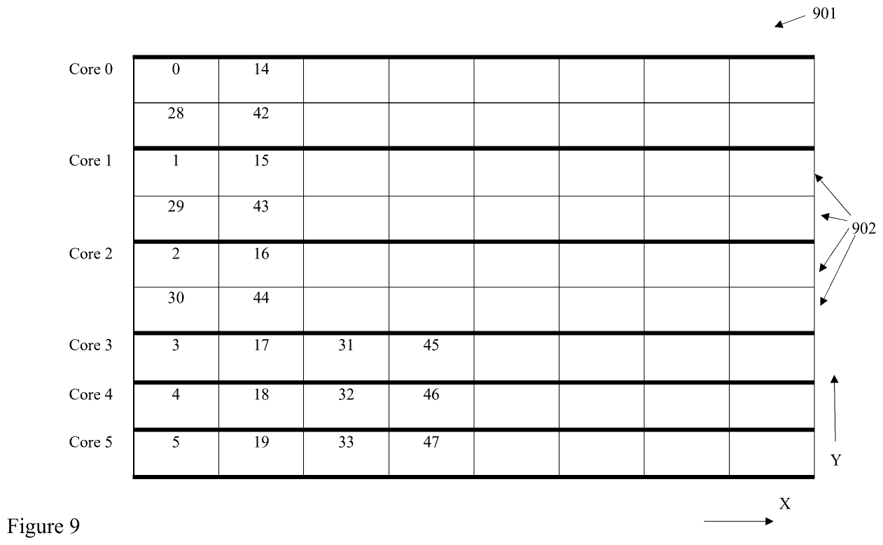

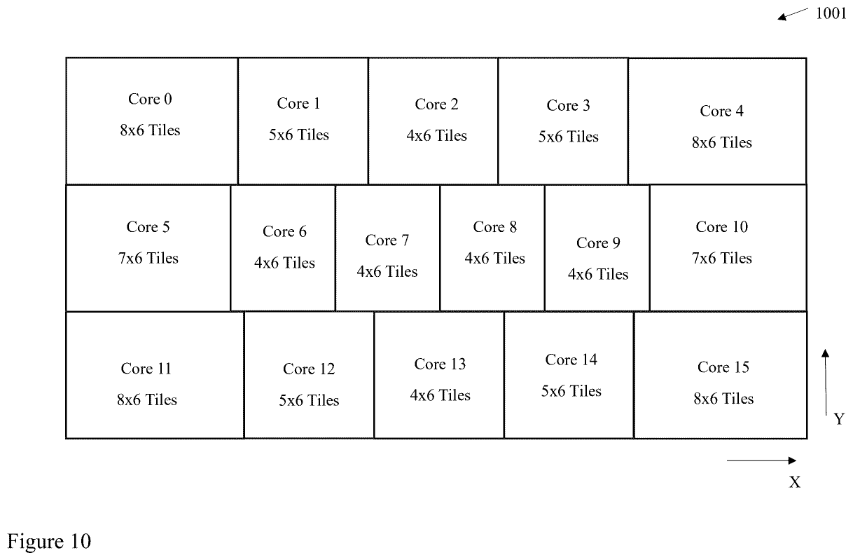

Examples of adaptively adjusting the initial region size for a subsequent job to be processed for one or more processors of the plurality of processors based on data relating to the processing of the current job by the one or more processors of the plurality of processors, is shown in FIGS. 9 and 10.

FIG. 9 shows a graphics processing system (e.g. data processing system) having 14 processors (cores), numbered 0 to 13 where in FIG. 9 only the first 6 cores are shown. A frame (e.g. job) 901 includes a plurality of tiles (e.g. tasks) 902, each tile 902 located at an X and Y coordinate of the frame, for example, from 0,0 through to X, Y. The example of FIG. 9 is based on round robin scheduling using horizontal regions for the 14 cores.

A volume is defined that, encompasses, the entire frame and therefore all of the tiles within the frame. The frame height in this example is 1080 pixels and the height of each tile is 64 pixels, meaning that there are 17 tiles in height (e.g. in the Y axis direction). As there are 14 cores then the volume is not naturally aligned to the frame in relation to evenly distributing the horizontal regions to the 14 cores. In this case, as there are 14 cores, the initial region size of each region includes a height of one tile and a width that extends along the frame in the X dimension (e.g. along the X axis), with the first 14 rows (e.g. rows 0 to 13) allocated as regions to each of the 14 cores (e.g. cores 0 to 13). The remaining three rows (e.g. rows 14 to 16) were initially defined as a shared region. In the example of FIG. 9, cores 0, 1, and 2 may be processing a simpler region of the render pass, such as a clear sky, and then subsequently processing the shared region. Thus, on completing the current job (e.g. frame), the analysis of the data indicates that cores 0, 1 and 2 processed and completed more tiles (e.g. tasks) including the tiles of the allocated region as well as the shared region. Accordingly, for the next, or subsequent frame (e.g. job) the region of cores 0, 1 and 2 are adaptively adjusted to be increased by 1 to be two tiles in height, as shown in FIG. 9. This results in an increased, or enlarged, region of 2 tiles in height for each of the cores 0, 1 and 2. In contrast, the remaining cores (e.g. cores 3 to 13) would have a region size that is not changed and thus being of 1 tile in height. This adaptive adjustment for the next, or subsequent frame (e.g. job) to increase the region size of three cores by 1 therefore removes the need for a shared region to be defined for the next render pass of the next frame.

FIG. 10 shows a graphics processing system (e.g. data processing system) having 16 processors (cores), numbered 0 to 15. A frame (e.g. job) 1001 includes a plurality of tiles (e.g. tasks), each tile located at an X and Y coordinate of the frame, for example, from 0,0 through to X, Y. The example of FIG. 10 is based on box regions for the 16 cores.

A volume is defined that, encompasses, the entire frame and therefore all of the tiles within the frame. The volume has a width of 1920 pixels and a height of 1080 pixels, with each tile being 64×64 pixels, thereby providing a 30×17 grid of tiles. Thus, the volume does not naturally align with the frame to provide an even distribution of tiles to each of the 16 cores. The initial region size (area) is 30 tiles and as such cores 0 to 14 are allocated a region of 6×5 tiles and core 15 is allocated a region of 15×2 tiles and a shared region is 15×2 tiles. On processing the frame, cores 0, 4, 11, and 15 which process the corner regions of the frame, which in this example are simpler, or less complex, regions and subsequently proceeded to process tasks from the shared region and further regions of the frame allocated to other cores. Cores 6, 7, 8, and 9 were allocated regions that included more complex tiles and as such did not process all of the tiles in the regions allocated to those cores. Thus, on analysing the data relating to the number of tiles (e.g. tasks) processed, or completed, by the respective cores, the region sizes are adaptively adjusted for the subsequent frame. In this example shown in FIG. 10, for the subsequent, or next, frame, the region size of cores 0,4,11, and 15 are increased to be 8×6 tiles and the region size of cores 6,7,8, and 9 are decreased to be 4×6 tiles, which also removes the need for a shared region to be defined for the next render pass of the next frame.

The above-described adaptive adjustment of the initial region size for one or more processors may be disabled when the similarity between the next, or subsequent job and the current, or previously processed job, is below a threshold. For example, if the job is a frame to be rendered for a scene and the scene changes, i.e. the similarity between the previous scene (frame) and the next scene (frame) is low, then it may be determined that there is a scene change between frames, and as such the adaptive adjustment of the region sizes may be disabled. For example, similarity may be determined based whether the camera position and direction has changed between frames, with little or low change (defined by a predetermined threshold) meaning that the frames are likely to have a high similarity. Alternatively, or additionally, similarity may be determined using (per pixel) motion vectors generated from one frame to the next frame, wherein if the motion vectors are below a given threshold then the frames may be considered to be similar and, conversely, if the motion vectors are over a given threshold the frames may be considered not to be similar. Alternatively, or additionally, similarity may be determined by comparing one or more average luminance values of consecutive frames (e.g. two or more of the previous frame(s), current frame and subsequent frame(s)), wherein if the difference between the average luminance values is below a given (e.g. predetermined) threshold, then the frames may be considered to be similar and, conversely, if the difference between the average luminance value is over a given threshold the frames may be considered not to be similar.

In embodiments, if it is determined that the next, or subsequent, frame (e.g. job) and the current, or completed previous, frame (e.g. job) have a high similarity, for example, in comparison to a threshold value, then it may be advantageous to allocate the same, or similar regions, of the next frame to the same cores that processed the respective region. This is advantageous as the core may retain data for the tiles (e.g. tasks) of the region allocated to that core in the previous which can be utilised for the processing of the tile at the same location in the region during the processing of the next, or subsequent frame.

As described in the above examples and embodiments, the task limit queue for each processor was set at 4. However, as will be appreciated, the task limit for the queues of each processor may be set at any value initially. Furthermore, the task limit for each of the queues for each processor may further be adaptively adjusted to maintain a more even workload balance between the processors of the plurality of processors. An even workload balance is preferable as the start of the processing for the next job may depend on the completion of the processing of the current job. In that case, some of the processors may remain idle after completing their tasks belonging to the current job whilst waiting other processor(s) to complete processing of their tasks belonging to the current job. As mentioned hereinabove, processors that complete the tasks of the region allocated to the given processor may subsequently process tasks of a shared region and/or tasks of a region allocated to a different processor. In order to enable, or provide, a more balanced distribution of workload, in particular, towards the end of processing a job, e.g. a render pass, the task queue limit for one or more processors may be adaptively adjusted.

Thus, in embodiments, each processor of the plurality of processors may be associated with a queue, each queue storing one or more tasks that are being processed by the processor, or waiting to be processed by the processor for the region allocated to the processor, wherein each queue has a task queue limit, and dynamically adjusting the task queue limit for one or more queues of the processor, for example, based on a complexity of the tasks in the region allocated to the processor, and/or on whether the processor has completed the tasks of the region allocated to the processor, either in the current frame or in the next, i.e. subsequent, frame(s). Complexity of tasks in a job may be determined by measuring the amount, or duration, of time it took to process each task in the previous completed job and determining a load of each processor based on the measurements for each task processed by the processor. Alternatively, or additionally, complexity may be determined by measuring the number of tasks completed by each processor in the previous frame, for example, if a first processor completed N tasks and a second processor completed 2N tasks, it can be determined that the first processor processed more complex tasks than the first processor. Based on the determination of the complexity the task queue limit for one or more processors can be dynamically adjusted for the next job. The task queue limit for one or more processors can also be dynamically adjusted during the processing of a current job. For example, if a first processor is still processing tasks from their allocated region whilst a second processor has completed the tasks of their allocated region, then it can be concluded that the first processor is processing tasks of higher complexity than the second processor, and the task queue limit of either or both of the first and second processors can be dynamically reduced, for example, dynamically reduced once the second processor has completed the tasks associated with the region allocated to the second processor and is then being allocated tasks of the region allocated to the first processor.

This approach advantageously mitigates the issue of workload imbalance between processors of the plurality of processors at the end of processing a job, for example, by maintaining the task queue limit for processors processing simple tasks and reduce the task queue limit by one or more for processors that process more complex tasks. Processing more complex tasks typically results in a higher deviation in execution times, thus increasing the likelihood of workload imbalance between processors. By reducing the number of queued complex tasks in processor may result in a more even workload balance. For instance, in the example shown in FIG. 10 cores 0, 4, 5, 10, 11, 15, which are processing tiles from “simpler” regions of the render pass, may maintain the initial task queue limit (e.g. a task queue limit of 4 tiles in this example), whilst cores 1, 3, 12, 14, which are processing tiles from “more complex” regions of the render pass, may reduce the task queue limit by, for example, one to 3, and cores 2, 6, 7, 8, 9, 13, which are processing “very complex” regions of the render pass, may reduce the task queue limit by, for example, two to 2. However, other arrangements are of course possible, where, depending in the initial task queue limit that is set for the data processing system, the task queue limit for one or more processors may be reduced by the same, or different number, ranging from one to one below the initially set task queue limit.

The dynamic adjustment of the task queue limit is also applicable to cores processing tiles from the shared region, if a shared region exists. For example, if a shared region exists then once one or more cores are processing tasks from the shared region, then those cores have completed their allocated regions which would indicate that most of the render pass has already been completed, and the task queue limit can be reduced. For example, the task queue limit can be reduced by one or more for cores processing tasks of the shared region. Once the tiles of the shared region have been completed such that the cores which processed tiles from the shared region start assisting with processing tiles of the regions allocated to other processors of the plurality of processors, the task queue limit can be further reduced by one or more for all cores. By dynamically adjusting the task queue limit for one or more processors of the plurality of processors a more balanced distribution of workload can be advantageously achieved, in particular, towards the end of a job, e.g. render pass. Thus, in embodiments that dynamically adjust the task queue limit based on the complexity of the tasks of the job maintains the utilisation of the plurality of processors of the data processing system thereby further improving the performance of the data processing system.

As described in the above examples and embodiments, each processor of the plurality of processors are considered as individual processors and are allocated regions separately, wherein each processor is operable to process tasks of a region allocated to the respective processor. However, other arrangements are possible, for example, by forming one or more groups, or sets, of two or more processors. By having one or more groups, or sets, of processors, each processor of a group may be allocated a spatially proximate, or local, regions which is advantageous as this enables optimised clock and power gating of processors included in a group under the assumption that processors of the group processing spatially neighbouring regions would complete their workloads at approximately the same time.

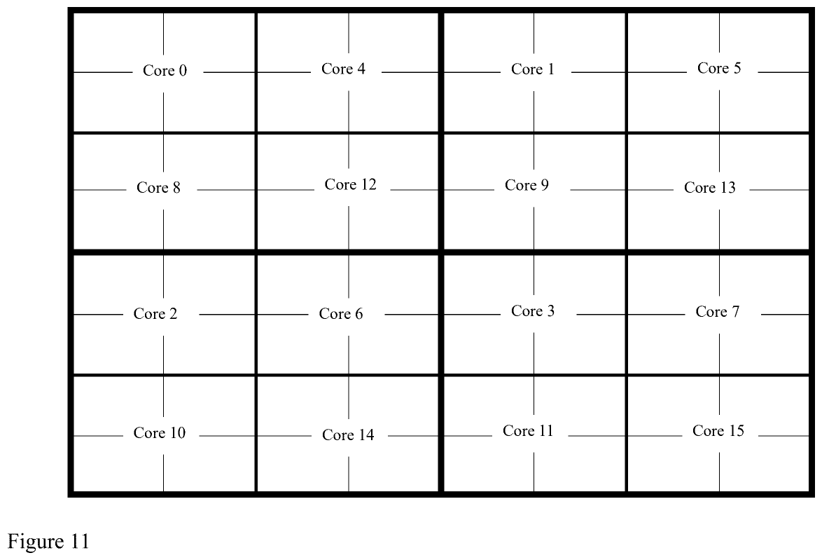

With reference to FIG. 11, there is shown a graphics processing system that includes 16 cores numbered 0 to 15. The frame (e.g. job) to be rendered has a height of 512×512 pixels and each tile (e.g. task) has a height of 64 pixels and a width of 64 pixels. A volume is defined around the frame which encompasses the whole frame. The volume is divided evenly into 16 regions using box regions, such that no shared region is necessary as the volume naturally aligns with the frame and the number of cores. In the example, of FIG. 11, the cores are then grouped into four groups, indicated by a bold line around the perimeter of each group, each comprising four cores, with Group 1 being cores 0, 4, 8, and 12, Group 2 being cores 1, 5, 9 and 13, Group 3 being cores 2, 6, 10, and 14, and Group 4 being cores 3, 7, 11, and 15. As can be seen in FIG. 11, the cores in each group are allocated regions that are spatially proximate, e.g. adjacent in at least one direction. The grouping shown in FIG. 11 is one example, where other groupings are of course possible, for example, the cores in each row may be grouped together (e.g. one group may be cores 0, 4, 1, and 5, and subsequent groups may correspond to each row of cores), or cores in each column may be grouped together (e.g. one group may be cores 0, 8, 2, and 10, and subsequent groups may correspond to each column of cores), and so on.

The data processing system may also be utilised to process compute jobs and/or neural jobs.

The examples provided hereinabove related to the rendering of frames (e.g. jobs) in a graphics processing system (e.g. data processing system). However, as previously described the data processing system can be directed to other processing requirements, for example, to process compute jobs, to process neural jobs, and so on. The embodiments described above therefore equally apply to any data processing system in which a job includes a plurality of tasks, wherein a volume can be defined that encompasses at least part of the job such that the volume can be divided into a plurality of regions based on the dimensions of the volume, the dimensions of a task, and the number of processors.

In relation to compute jobs, the compute jobs may process tasks relating to any data on which the compute jobs are applied, for example, to process image data. An example may include averaging a number of (rendered) frames, e.g. to average the previous three (rendered) frames image data. In this example, the compute job will typically be a three-dimensional job that includes three layers (e.g. a depth of 3), each layer (z) being one of the previous three frames image data having a height (y) and width (x) corresponding to the height and width of the frame. A volume is defined having three dimensions and includes, or encompasses, at least part of the three-dimensional compute job. The volume is then divided into a plurality of three-dimensional regions based on the dimensions of the volume, the dimensions of the tasks and the number of processors in the data processing system. In this example, the compute job relates to averaging (rendered) frames image data and as such the dimensions of the volume and the tasks may be defined in pixels. The three-dimensional regions, wherein each three-dimensional region includes spatially proximate tasks that correspond to image data from each layer (i.e. from each frame) at a respective corresponding location in each layer, can then be allocated to each processor for processing and outputting the average image data.

Furthermore, in the above-described example of a compute job each of the Red, Green, and Blue channels of each frame (x, y) were processed together, however, each of the colour channels may be processed separately meaning that the compute job would include nine layers (z) (e.g. a depth of 9) for the three frames, e.g. each frame may include three layers corresponding to each of the three colour channels.

In relation to neural jobs, the neural jobs may process (machine learning) tasks relating to any data on which the neural jobs are applied, for example, to process image data. The neural jobs may typically include four dimensions (NHWC), for example, a batch (N), a height (H), a width (W) and a channel (C). In terms of the channel, in the case that the channel relates to the colour in the image data then the Red, Green, and Blue may be processed as three separate channels for the image data, thereby increasing the depth of the neural job. In addition, the hidden layers in the neural network and the number of channels may be same as the number of kernels in a previous layer. A four-dimensional volume can be defined that includes at least part of the four-dimensional neural job. The volume is then divided into a plurality of four-dimensional regions based on the dimensions of the volume, the dimensions of the tasks and the number of processors in the data processing system. The four-dimensional regions, wherein each four-dimensional region includes spatially proximate tasks can then be allocated to each processor for processing.

In embodiments, the described features of the fragment job processing, e.g. determining shared regions, adaptively adjusting a region size, dynamically adjusting a task queue limit, grouping processors, and so on, equally apply to both the compute jobs and the neural jobs.

In the above embodiments and examples, the dimensions of the defined volume and the tasks forming the job have been described as being in pixels. However, other dimensions can be used depending on the required processing and as such, the dimensions may be defined as any suitable dimension for the job that is being processed and the tasks forming the job.

Thus, embodiments of the present disclosure advantageously divide jobs (in two, three, four, or further dimensions) into a plurality of regions, wherein each region includes spatially proximate tasks, and allocating each region to a processor of the plurality of processors of the data processing system.

In the foregoing embodiments and examples, features described in relation to one embodiment and/or example may be combined, in any manner, with features of a different embodiment and/or example in order to provide a more efficient and effective arrangement of a data processing system having a plurality of processors for processing a job that includes a plurality of tasks. Note that, the above description is for illustration only and other embodiments and variations may be envisaged without departing from the scope of the invention as defined by the appended claims.

The various functions of the present invention can be carried out in any desired and suitable manner. For example, unless otherwise indicated, the functions of the present invention herein can be implemented in hardware or software, as desired. Thus, for example, unless otherwise indicated, the various functional elements, stages, and “means” of the invention may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the present invention may be duplicated and/or carried out in parallel on a given processor. Equally, the various processing stages may share processing circuitry/circuits, etc., if desired.

Furthermore, unless otherwise indicated, any one or more or all of the processing stages of the present disclosure may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuits of the present disclosure may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics and/or data processor can otherwise include any one or more or all of the usual functional units, etc., that graphics and/or data processors include.

The methods in accordance with the present disclosure may be implemented at least partially using software e.g. computer programs. It will thus be seen that the present invention herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The present disclosure also extends to a computer software carrier comprising such software which when used to operate a display controller, or microprocessor system comprising a data processor causes in conjunction with said data processor said controller or system to carry out the steps of the methods of the present disclosure. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the present disclosure need be carried out by computer software and thus, in a further broad embodiment the present disclosure provides computer software and such software installed on a computer software carrier for carrying out at least one of the steps of the methods set out herein.

The present disclosure may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

1. A method of operating a data processing system that comprises a plurality of processors operable to process a job, wherein the job is divided into a plurality of tasks, and each processor of the plurality of processors is operable to process one or more tasks of the job, the method comprising:
defining a volume having two or more predetermined dimensions, wherein the volume includes at least part of the job;
dividing the volume into a plurality of regions based on one or more predetermined dimensions of the volume, one or more corresponding dimensions of a task and the number of processors, each region having an initial region size and each region includes spatially proximate tasks;
initially allocating each of the plurality of regions to a processor of the plurality processors; and
allocating a task within a region to the processor that is allocated to the region.

2. The method of claim 1, further comprising:
identifying that the plurality of regions of the initial region size do not align with the number of processors;
adjusting the initial region size to an adjusted region size lower than the initial region size;
allocating each of the plurality of regions of the adjusted initial region size to a processor of the plurality of processors;
determining a shared region corresponding to one or more tasks not included in the allocated regions of the adjusted initial region size; and
enabling tasks in the shared region to be allocated to any of the plurality of processors.

3. The method of claim 2, in which if a processor completes processing tasks in the processors allocated region, the method further comprises:
processing one or more tasks of the shared region; and/or
processing one or more tasks of a region allocated to a different processor.

4. The method of claim 1, in which each region corresponds to:
a horizontal region having a height corresponding to the initial region size;
a vertical region having a width corresponding to the initial region size;
a box region having an area corresponding to the initial region size; or a hypercube region having a volume corresponding to the initial region size.

5. The method of claim 1, further comprising:
determining a level of similarity between the current job and a subsequent job; and
if the level of similarity is high, allocating the same or similar regions of the subsequent job to each processor that was allocated the regions in the current job.

6. The method of claim 5, in which determining a level of similarity comprises:
comparing a camera position and/or direction between the subsequent job and the current job is below with a predetermined threshold; and/or
comparing motion vectors generated from the current job and the subsequent job to a predetermined threshold; and/or
comparing one or more average luminance values of consecutive jobs to a predetermined threshold.

7. The method of claim 1, further comprising:
adaptively adjusting the initial region size for a subsequent job to be processed for one or more processors of the plurality of processors based on data relating to the processing of the current job by the one or more processors of the plurality of processors.

8. The method of claim 7, in which the data includes a number of tasks processed by each processor, the method further comprising:
comparing the number of tasks processed by each processor;
increasing the initial region size for the subsequent job for a first processor that processed more tasks than a second processor during the current job; and
decreasing the initial region size for the subsequent job for the second processor that processed fewer tasks than the first processor during the current job.

9. The method of claim 7, in which the adaptive adjustment of the initial region size is disabled when a determined similarity is low between the subsequent job and the current job.

10. The method of claim 9, in which determining similarity comprises:
comparing a camera position and/or direction between the subsequent job and the current job with a predetermined threshold; and/or
comparing motion vectors generated from the current job and the subsequent job to a predetermined threshold; and/or
comparing one or more average luminance values of consecutive jobs to a predetermined threshold.

11. The method of claim 1, in which each processor of the plurality of processors is associated with a queue, each queue storing one or more tasks that are being processed by the processor, or waiting to be processed by the processor for the region allocated to the processor, wherein each queue has a queue limit, the method further comprising:
dynamically adjusting the queue limit for one or more queues of the processor based on a determined complexity of the tasks in the region allocated to the processor.

12. The method of claim 11, in which determining complexity comprises:
measuring a duration of time to process each task for each processor; and/or
measuring a number of tasks processed by each processor.

13. The method of claim 3, in which each processor of the plurality of processors is associated with a queue, each queue storing one or more tasks that are being processed by the processor, or waiting to be processed by the processor for the region allocated to the processor, wherein each queue has a queue limit, the method further comprising:
dynamically adjusting the queue limit for one or more queues of the processor based on the processor processing tasks from the shared region.

14. The method of claim 1, further comprising:
forming one or more groups of processors, wherein each group includes two or more processors of the plurality of processors; and
allocating regions that are spatially proximate to the processors of a group of processors.

15. The method of claim 1, further comprising:
allocating tasks in a region to the processor allocated to that region based on a processor scan order, wherein the scan order includes one of a horizontal scan order, a vertical scan order, and a Z scan order.

16. The method of claim 1, in which the data processor is a graphics processor, the job is a fragment job, the volume is a two-dimensional volume, and the plurality of tasks are tiles.

17. The method of claim 1, in which the job is a compute job, the volume is a three-dimensional volume, and the plurality of tasks are compute tasks.

18. The method of claim 1, in which the job is a neural job, the volume is a four-dimensional volume, and the plurality of tasks are neural tasks.

19. A data processing system, comprising:
a plurality of processors operable to process a job, wherein the job includes a plurality of tasks, and each processor of the plural processors is operable to process one or more tasks of the job;
a region allocator, wherein the region allocator allocates one or more regions to each of the processors of the plurality of processors; and
a task allocator, wherein the task allocator allocates tasks to each of the processors of the plurality of processors,
wherein the data processing system is operable to implement a method according to claim 1.

20. A computer program product comprising computer readable executable code for implementing a method according to claim 1.
